(19) United States
(12) Patent Application Publication
(10) Pub. No.: US 2004/0174288 A1
(43) Pub. Date: Sep. 9, 2004

(54) Programmable universal control

(76) Inventor: Chang K. Park, New Rochelle, NY (US)

Correspondence Address: OSTROLENK FABER GERB & SOFFEN, 1180 AVENUE OF THE AMERICAS, NEW YORK, NY, 100368403

(21) Appl. No.: 10/792,124

(22) Filed: Mar. 3, 2004

Related U.S. Application Data
(60) Provisional application No. 60/523,244, filed on Nov. 17, 2003.
(60) Provisional application No. 60/451,991, filed on Mar. 5, 2003.

(51) Int. Cl. G08C 19/12; H04L 17/02; G09G 5/00

(52) U.S. Cl. 341/176

(57) ABSTRACT

A universal remote control unit for remotely controlling a plurality of devices each belonging to a respective device category, which includes a plurality of lights corresponding to each device category and a processor having a programming mode for programming the processor to control a particular device. The lights are caused to sequentially turn on, as by actuating one or more buttons of the remote, or by causing selective actuation of directional buttons of the remote control. When the light associated with the device category of the particular device it is desired to program is lit, the processor is the placed in the programming mode. Then, the processor is programmed to operate the particular device.

### CROSS REFERENCE TO RELATED APPLICATIONS

This application is based on and claims the priority to U.S. Provisional Application S. No. 60/451,991 filed Mar. 5, 2003 and entitled “PROGRAMMING A UNIVERSAL REMOTE CONTROL” and to Provisional Application S. No. 60/523,244 filed Nov. 17, 2003 and entitled “PROGRAMMING A UNIVERSAL REMOTE CONTROL.”

### BACKGROUND OF THE INVENTION

The present invention relates generally to remote control units, and more particularly, to universal remote control units for remotely controlling a plurality of appliances or devices.

It is common to include a ‘multifunction’ or ‘Universal’ remote control (URC) hand-held transmitter with many consumer products (also referred to herein as devices, apparatus or appliances) such as televisions, video cassette recorders (VCR), digital video disk players (DVD), satellite receivers, compact disk players, and audio systems. The advantage of URC's is that the consumer can control not only the particular device with which it was sold (hereafter referred to as “first” device(s)), but the consumer can use the same URC to control any of the other devices (hereinafter referred to as “different” device(s)).

In order to control a different device other than the first device it is necessary to set up or program the URC to operate that device. There are several ways that are used to do this. Two of the most popular are the “scanning or point and press mode” and the “code entry mode.”

An example of the scanning mode is disclosed in U.S. Pat. No. 4,703,359 (“the '359 patent). In accordance with the '359 patent, the user sets the device to be controllable by the remote control unit, to execute some observable action when receiving a specific command signal from the remote, referred to as a “response-evoking signal.”

For example, if the device is a television set, the observable action may be a channel change and the response-evoking signal would be a “channel up” signal. The user then activates a selector device such as a keyboard to put the remote control unit into the “identify” mode by depressing a category button and an identity button. The microprocessor within the unit then executes an “identify” program and the unit transmits response command signals (e.g., channel up signals) in a variety of signal structures appropriate for different manufacturers and different model numbers. The device will react to the one response command signal which has the required signal structure.

An example of the code entry method is disclosed in U.S. Pat. No. 5,872,562 (“the '562 patent”). In accordance with the '562 patent, all of the signal formats for the different categories and manufacturers of devices are permanently stored in a memory at respective memory addresses.

To set up or program the remote control to control a particular device with the '562 patent, the user first activates an entry key. Thereafter the user selects one of a plurality of keys, each signifying a particular category. Finally, the user activates at least one key to signify the address in the memory storing the specific formatting date.

### SUMMARY OF THE INVENTION

The object of the present invention is to provide a programmable universal remote control in which it is not necessary to actuate a category button in order to program the remote control.

These and other objects are achieved in accordance with certain features of the invention by a universal remote control unit which includes a plurality of lights corresponding to each category of device it is desired to control, and means for sequentially turning on each of the lights. A processor having a programming mode is provided for programming the processor to control a particular device. The processor is placed in the programming mode when the light associated with the device category of the particular device it is desired to program is lit. Means are provided for programming the processor to operate the particular device when the processor is in the programming mode.

In accordance with one aspect of the invention, actuating at least one button of the universal remote control causes the lights to be turned on sequentially.

In accordance with another aspect of the invention, the lights are sequentially turned on by selectively actuating directional buttons of the universal remote control.

Other features and advantages of the present invention will become apparent from the following description of the invention which refers to the accompanying drawings.

### BRIEF DESCRIPTION OF THE DRAWING(S)

FIG. 1 is a front plan view of a representative of a universal remote control unit according to the present invention for controlling several devices or appliances;

FIG. 2 is a block diagram of the universal remote control unit shown in FIG. 1;

FIG. 3 is a flow chart of a process for operating the remote control unit shown in FIG. 1 in accordance with a first embodiment of the code entry method of programming;

FIG. 4 is a flow chart of a process for operating the remote control unit shown in FIG. 1 in accordance with a variant of the first embodiment of the code entry method of programming;

FIG. 5 is a flow chart of a process for operating the remote control unit shown in FIG. 1 in accordance with another variant of the first embodiment of the code entry method of programming;

FIG. 6 is a flow chart of a process for operating the remote control unit in FIG. 1 in accordance with the first embodiment of the point and press mode programming;

FIG. 7 is a flow chart of a process for operating the remote control unit in FIG. 1 in accordance with a variant of the first embodiment of the point and press mode programming;

FIG. 8 is a flow chart of a process for operating the remote control unit in FIG. 1 in accordance with another variant of the first embodiment of the point and press mode programming;

FIG. 9 is a flow chart of the process for operating the remote control unit shown in FIG. 1 in accordance with the second embodiment of the code entry method of programming;

FIG. 10 is a flow chart of the process for operating the remote control unit shown in FIG. 1 in accordance with a variant of the second embodiment of the code entry method of programming;

FIG. 11 is a flow chart of the process for operating the remote control unit shown in FIG. 1 in accordance with another variant of the second embodiment of the code entry method of programming;

FIG. 12 is a flow chart of a process for operating the remote control unit in FIG. 1 in accordance with a second embodiment of the point and press method of programming;

FIG. 13 is a flow chart of a process for operating the remote control unit in FIG. 1 in accordance with a variant of the second embodiment of the point and press method of programming; and

FIG. 14 is a flow chart of a process for operating the remote control unit in FIG. 1 in accordance with another variant of the second embodiment of the point and press method of programming.

### DETAILED DESCRIPTION OF PREFERRED EMBODIMENT(S)

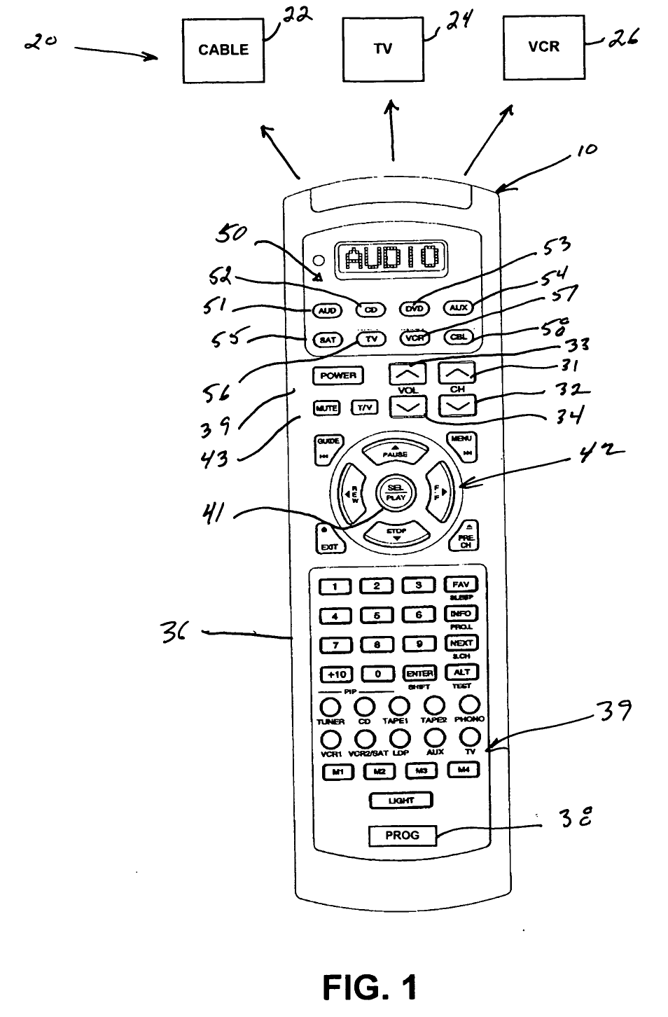

FIG. 1 illustrates an exemplary universal remote control unit 10 in accordance with certain features of the present invention for controlling a plurality of devices 20.

Although the embodiment of universal remote control unit 10 shown in FIG. 1 can control eight different devices 20, for the sake of simplicity only three are shown: a cable box 22, a television set 24 and a VCR 26. As will be appreciated from the following description, the invention is not limited to controlling only eight devices but may be used to control any number of devices.

With reference to FIG. 1, universal remote control unit 10 includes input means in the form of a keyboard 30 for enabling a user to select a plurality of function in connection with the operation of the plurality of devices 20. As best shown in FIG. 1, keyboard 30 may include channel up and down push buttons 31 and 32, volume up and down push buttons 33 and 34, a plurality of numbered digit push buttons 36, a programming push button 38, a plurality of video function and other device push buttons 39 and a power push button 40.

In addition, the universal remote control 10 also includes selector button 41, up, down, left, and right directional buttons 42, a mute push button 43 for muting sound change, and a plurality of category or device mode push buttons 50 such as an Audio (AUD) push button 51, a CD push button 52, a DVD push button 53, an Auxiliary (AUX) push button 54, a satellite (SAT) push button 55, a TV push button 56, a VCR push button 57 and a Cable (CBL.) push button 58. Each category button 50 identifies one of the operating modes of universal remote control 10. For example, universal remote control unit 10 in its cable mode operates the functions of the cable box 22. In its television mode, universal remote control unit 10 operates the functions of television set 24. Each of the plurality of category push buttons 50 has lights associated therewith, such as by being under, on top or embedded in the buttons.

All of the push buttons with the exception of the digit push buttons 36 will be collectively referred to a “function buttons.”

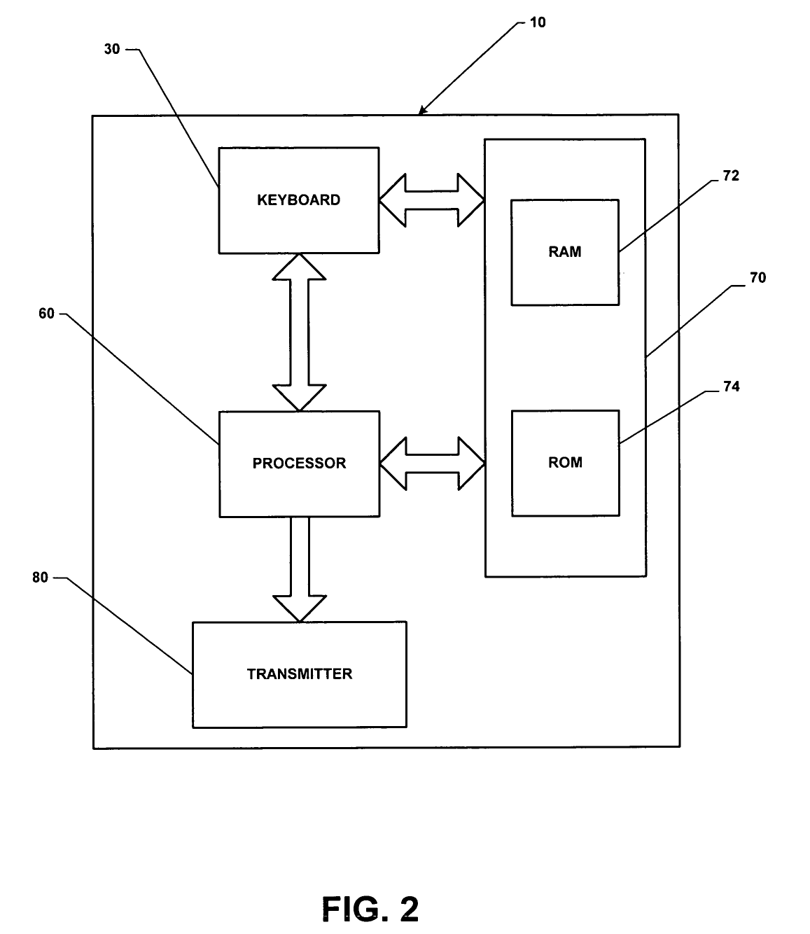

With reference to FIG. 2, universal remote control unit 10 includes, in addition to keyboard 30, a processor 60 having a plurality of operating mode each of which corresponds to a different one of the plurality of devices 20 (FIG. 1), a memory 70 comprising a ROM 72 and a RAM 74, and a transmitter 80, such as an infrared transmitter. Activation of one of the plurality of push buttons of keyboard 30 by a user generates a command signal when depressed. This command is supplied to processor 60. In response thereto, processor 60 retrieves an appropriate control code(s) from memory 70. Processor 60 then causes the transmitter 80 to generate pulses in accordance with the control code(s). The pulses are received by one of the plurality of devices 20 (FIG. 1) thereby causing the device to carry out the command function.

Processor 60 is run by application software or programming, e.g., assembly language, and is typically governed by the manufacturer's protocol.

From the following description, computer readable program code means for use in processor 60 and for implementing the present invention may be readily programmed by those skilled in the art and stored in memory 70.

First Embodiment

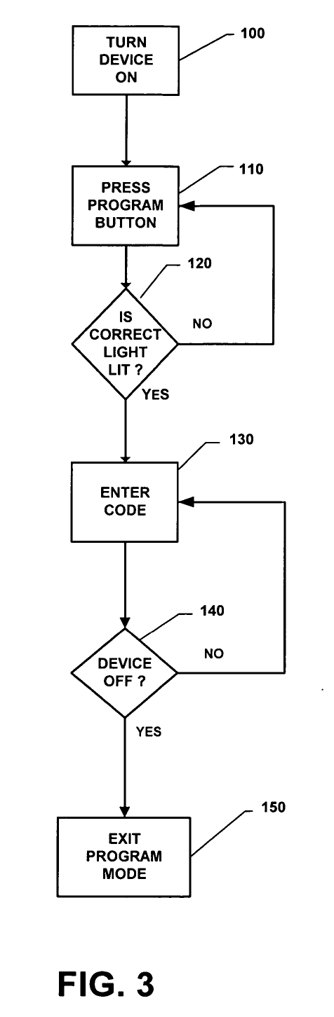

FIGS. 3-8 are flow diagrams for programming the remote control 10 in accordance with a first embodiment of the invention.

Code Entry

Turning first to FIG. 3 there is shown a flow chart for a code entry method of programming in accordance with the first embodiment of the present invention.

At step 100 power to the device 20 to be programmed is turned on. Then at step 110, the programming button 37 is pressed. The lights associated with the device buttons 50 will then rotate being lit in a timed sequence, e.g., one second intervals, while the programming button 37 is being pressed. The programming button 37 is released when the light associated with the device one wishes to program lights up (step 120). The light associated with the device button that was selected will remain lighted for a period of time, e.g., thirty seconds.

In step 130, a device code number (generally three digits) is then entered by sequential depression of the corresponding digit buttons while the device light is on (i.e., within the thirty-second period after the programming button 37 is released) and while the universal remote control 10 is pointed at the device 20. The device 20 will turn off if the device code number is correct. If the device 20 does not turn off (step 140) another device code is entered. Steps 130 and 140 are repeated until the device turns off. After this occurs, the programming mode is exited (step 150) by depressing the programming button 37 once again or by depressing any pre-designated button.

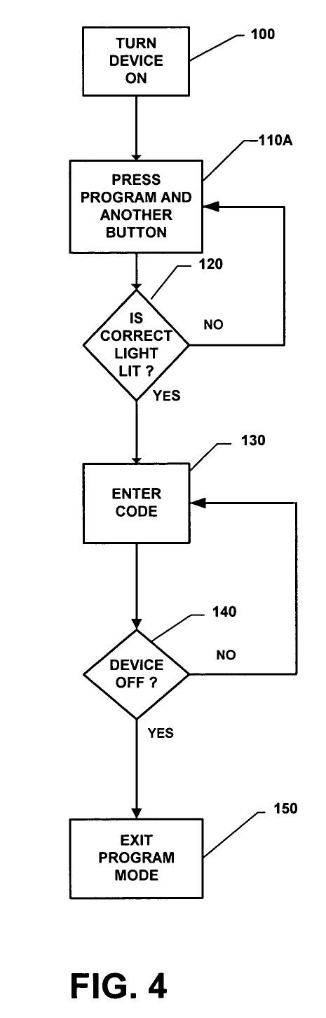

Alternatively, as seen in FIG. 4, in order to prevent unintentional programming, in lieu of only pressing the programming button 37 in step 110 of FIG. 3, the programming button 37 and another functional button, e.g., the mute button 43, are simultaneously pressed in step 110A.

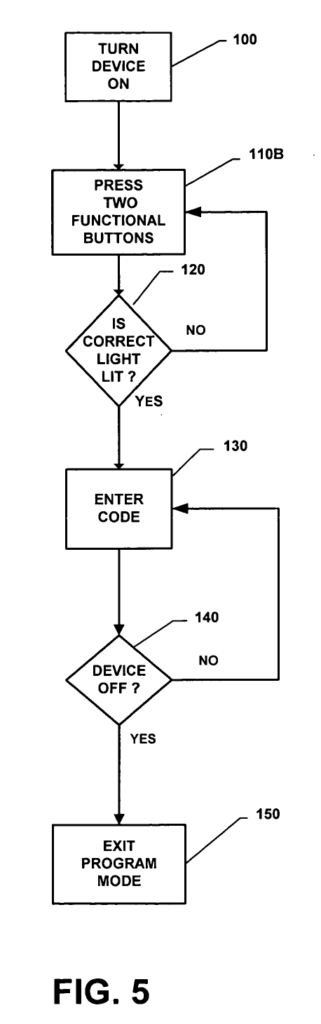

FIG. 5 shows a further alternative which eliminates the need for a separate programming button. Instead, as seen in step 110B, the code entry process may be initiated by simultaneously pressing any two functional buttons, such as the mute and enter push buttons 43 and 37, or the mute and select push buttons 43 and 41 for a period of time (e.g., three seconds).

Point and Press

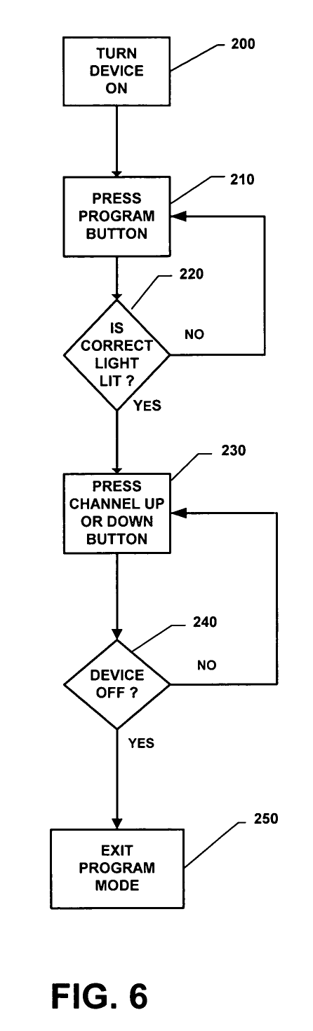

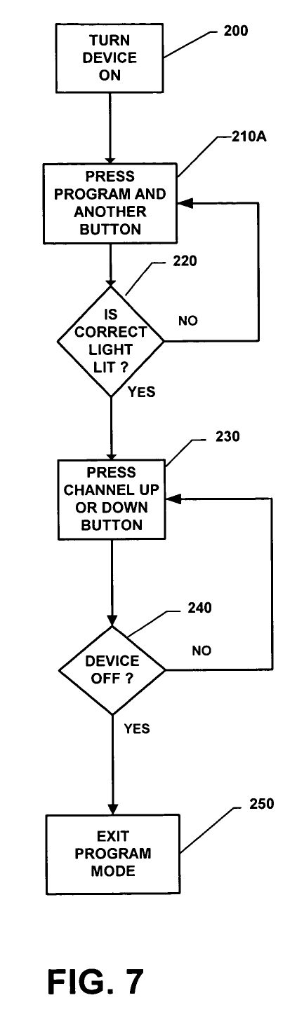

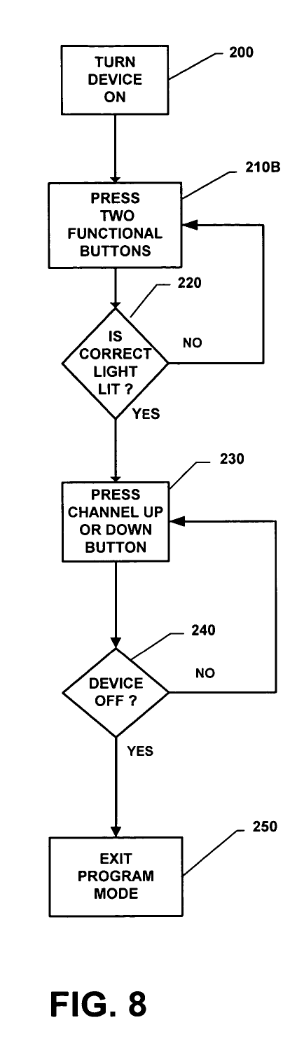

Referring to FIGS. 6-8, in using in the “point and press” method of programming the universal a remote control 10 in accordance with the first embodiment of the invention, after the device 20 one wishes to control is turned on (step 200, FIGS. 6-8), the programming button 37, or the programming button 37 and another functional button, or two functional buttons (hereinafter “setting button or buttons”), are pressed (step 210, FIG. 6; step 210A, FIG. 7; or step 200B, FIG. 8) to cause lights associated with the device 20 to rotate. When the light associated with the selected device 20 lights up, the setting button (or buttons) is released (step 220, FIGS. 6-8). The universal remote control 10 is then pointed at the selected device 20 and a functional button (e.g., the channel up button 31 or the channel down button 32) is pressed (step 230, FIGS. 6-8). The functional button is released when the selected device executes a desired function, such as turning off (step 240, FIGS. 6-8). After this occurs, the programming mode is exited (step 250) by depressing the programming button 37 once again or by depressing any pre-designated button. The remote control is now programmed to operate the device.

Second Embodiment

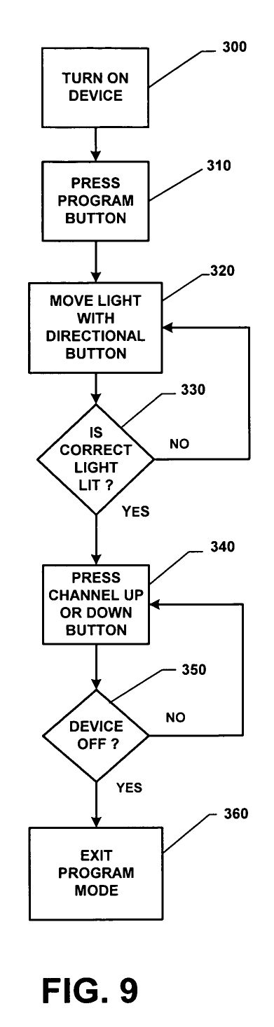

FIGS. 9-14 are flowcharts illustrating methods of programming the universal remote control 10 for a particular device 20 in accordance with a second embodiment of the invention

Code Entry

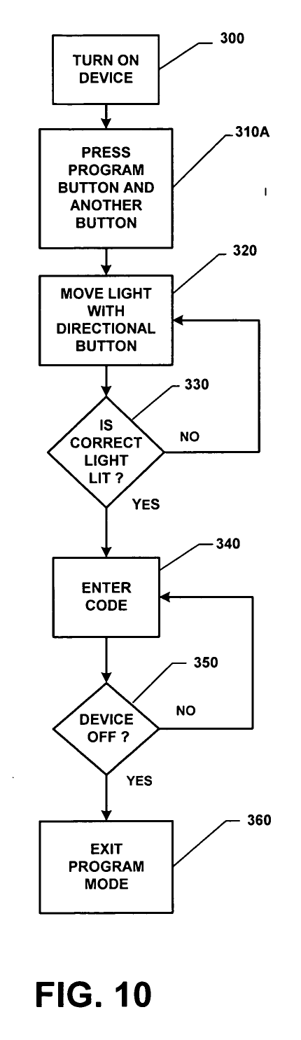

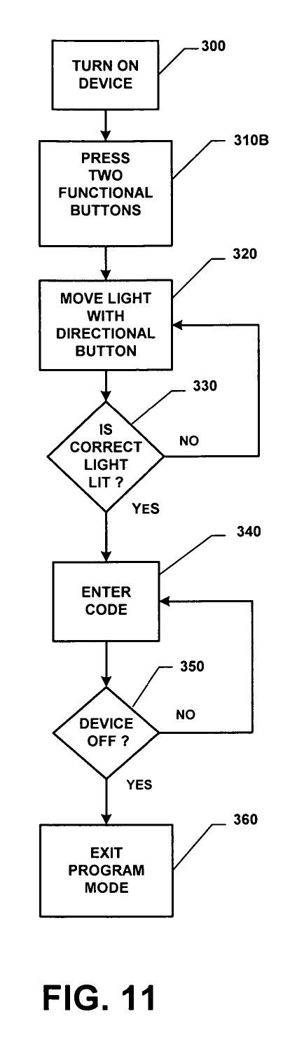

Turning first to FIGS. 9-11, the first step of the code entry method of the second embodiment, like the first step of the first embodiment, is to turn on the power of the device 20 to be programmed off (step 300, FIGS. 9-11). Then, the programming button 37, or the programming button 37 and another functional button, or two functional buttons (hereinafter “setting buttons or buttons”), are pressed (step 310, FIG. 9; step 310A, FIG. 10; or step 310B FIG. 11). A light associated with one of the device buttons 50 will light and stay on, indicating that the remote control 10 is in a programming mode (step 320, FIGS. 9-11). Preferably, the device button that stays on is the one on either the extreme right or left of the remote control 10. The light is then moved manually (step 330, FIGS. 9-11) by the user to the device button 50 representing the device to be programmed by using the left or right directional buttons 42 of the remote control.

A device code number (generally three digits) is then entered by sequential depression of the corresponding digit buttons while the device light is on and while the universal remote control 10 is pointed at the device (step 340, FIGS. 9-11). The device will turn off if the device code number is correct. If the device does not turn off, another device code is entered. (Step 350, FIGS. 9-11). Steps 340 and 350 are repeated until the device turns off. After this occurs, the programming mode is exited by depressing the programming button 37 (step 360, FIGS. 9-11) or by depressing any pre-designated button.

If it is desired to program more than one device, the program for the first device is saved by pressing one button, such as the select button 41. The device light will blink twice or so to confirm the saved code. The light will remain on and the light is moved either automatically to the next device light or manually by the user to the next device to be programmed using the left or right directional button. The appropriate device code is then entered and the program is saved by pressing the select button 41 or by depressing any pre-designated button. After all the devices that one desires to program have been programmed, the programs are saved and the programming mode is exited by pressing a different button, such as the mute button 43.

Point and Press

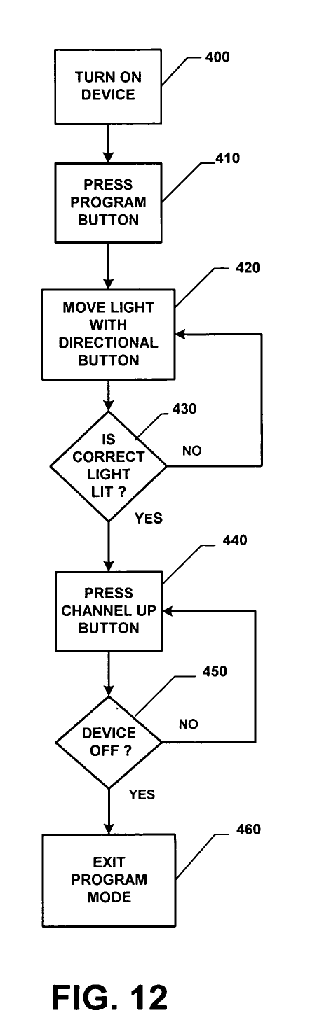

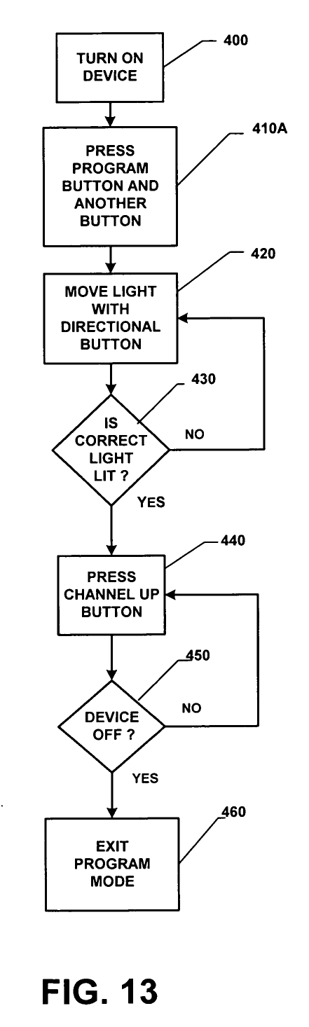

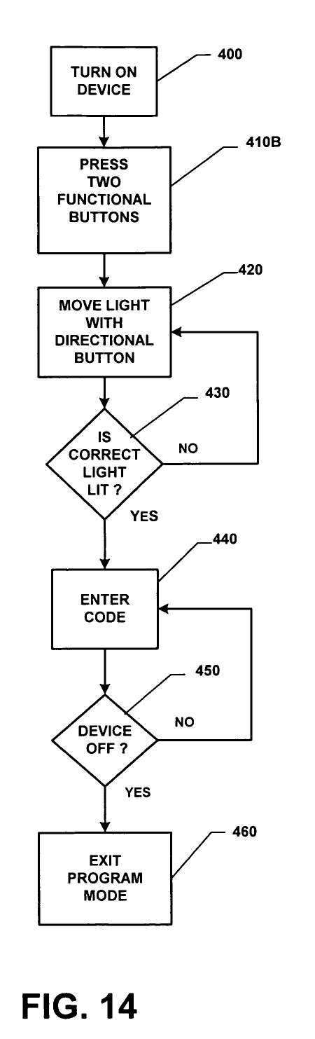

Referring now to FIGS. 12-14, in the “point and press' method of programming a remote control in accordance with the second embodiment, after the device one wishes to program is turned on (step 400, FIGS. 12-14), the programming button, or the programming button and another functional button, or two other buttons, such as the select and mute buttons 41 and 43 (hereinafter “setting button or buttons”), are pressed for a period of time (e.g., three seconds)(step 410, FIG. 12, step 420A, FIG. 13; or step 410B, FIG. 14) FIG. 8 to cause one of the lights associated with the device buttons to stay on. The light is then moved by using the directional buttons to the device it is desired to program (step 420, FIGS. 12-14).

The remote control is then pointed at the selected device and a functional button (e.g., the channel up button 31 or the channel down button 32) is pressed (step 430, FIGS. 12-14) The functional button is released when the selected device executes a desired function, such as turning off the device (step 440, FIGS. 12-14). The functional button could also be pressed multiple times in order to send out one code at a time. After the device turns off, the code is saved and the programming mode exited by pressing a different button, such as the mute button 43 (step 460, FIGS. 12-14). The remote control 10 is now programmed to operate the device.

If it is desired to program more than one device, the program for the first device is saved by pressing one button, such as the select button 41. The device light will blink twice or so to confirm the saved code. The light will remain on and the light is moved either automatically to the next device light or manually by the user to the next device it is desired program using the left or right directional button. The remote control is then pointed at the selected device once again and a functional button (e.g., the channel up button 31 or the channel down button 32) is pressed. The functional button is released when the selected device executes a desired function, such as turning off. The functional button could also be pressed multiple times in order to send out one code at a time. The program is saved by pressing another function button, such as the select button 41. After all the devices that one desires to program have been programmed, the programs are saved and the programming mode exited by pressing a different button, such as the mute button 43.

Any suitable universal control may be programmed to implement the invention. Examples of suitable unviersal remote controls are the SL-7000, the SL-8000, the SL-9000, the HRMC-12, the HRMC-13 and the UR3-EXP available from Universal Remote Controls, Inc., Harrison, N.Y.

It should be appreciated that although the foregoing description refers to push buttons, the invention is not so limited and any other input devices, such as touch and proximity pads and touch and proximity screens, may be used. Accordingly, the term “button(s)” as used herein and in the claims is intended to refer to any means for entering data, control commands, operation commands, programming data or commands, or any other type of information.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A universal remote control unit for remotely controlling a plurality of remotely controllable devices each belonging to a respective device category, the universal remote control unit comprising:
a plurality of lights corresponding to each device category;
means for sequentially turning on each of the lights;
a processor having a programming mode for programming the processor to control a particular device;
means for placing the processor in the programming mode when the light associated with the device category of the particular device it is desired to program is lit; and
means for programming the processor to operate the particular device when the processor is in the programming mode.

2. The universal remote control of claim one, wherein the means for sequentially turning on the lights include a plurality of directional buttons.

3. A universal remote control unit for remotely controlling a plurality of remotely controllable devices each belonging to a respective device category, the universal remote control unit comprising:
an input unit for enabling a user to select a plurality of functions in connection with the operation of the plurality of devices;
a plurality of lights corresponding to each device category;
means for sequentially turning on each of the lights;
a transmitter;
a processor having a plurality of operating modes each of which corresponds to a different one of the plurality of devices, the processor being operable in each of the plurality of operating modes to control transmission from the transmitter in response to activation of the function means by the user; the processor further having a programming mode for programming the operating modes of the processor;
means for placing the processor in the programming mode when the light associated with the device category of a particular device it is desired to program is lit; and
means for programming the processor to operate the particular device when the processor is in the programming mode.

4. A universal remote control unit for remotely controlling a plurality of remotely controllable devices each belonging to a respective device category, the universal remote control unit comprising:
an input unit for enabling a user to select a plurality of functions in connection with the operation of the plurality of devices;
a plurality of lights corresponding to each device category;
means for sequentially turning on each of the lights;
a transmitter;
a processor having a plurality of operating modes each of which corresponds to a different one of the plurality of devices, the processor being operable in each of the plurality of operating modes to control transmission from the transmitter in response to activation of the function means by the user; the processor further having a programming mode for programming the operating modes of the processor;
means for placing the processor in the programming mode when the light associated with the device category of a particular device it is desired to program is lit;
means for programming the processor to operate the particular device when the processor is in the programming mode; and
the processor being operable in a selected one of the plurality of operating modes upon receiving an input from the input units.

5. A universal remote control unit for remotely controlling a plurality of remotely controllable devices each belonging to a respective device category, the universal remote control unit comprising:
a plurality of lights corresponding to each device category;
means for sequentially turning on each of the lights;
a transmitter;
a processor having a plurality of operating modes each of which corresponds to a different one of the plurality of devices, the processor being operable in each of the plurality of operating modes to control transmission from the transmitter in response to activation of the function means by the user; the processor further having a programming mode for programming the operating modes of the processor,
a keyboard having a plurality of buttons, at least one of the buttons upon actuation placing the processor in the programming mode when the light associated with the device category of a particular device it is desired to program is lit; and at least one of the buttons upon actuation programming the processor to operate the particular device when the processor is in the programming mode; and
the processor being operable in a selected one of the plurality of operating modes upon actuation of at least one of the buttons.

6. A system comprising:
a remotely controllable device; and
a universal remote control unit of any one of claims 1-5 for remote control of the device.

7. A method of enabling a universal remote control to remotely controlling a plurality of remotely controllable devices each belonging to a respective device category, the universal remote control unit having a plurality of lights corresponding to each device category and a processor having a programming mode for programming the processor to control a particular device; which method comprises:
sequentially turning on each of the lights;
placing the processor in the programming mode when the light associated with the device category of the particular device it is desired to program is lit; and
programming the processor to operate the particular device when the processor is in the programming mode.

8. The method of claim 7, wherein the universal remote control includes a plurality of directional buttons and the step of sequentially turning on the lights includes selectively actuating the directional buttons.

9. The method of claim 8, wherein the universal remote control further includes a plurality of other buttons and the step of sequentially turning on the lights includes actuating at least one of the other buttons prior to actuating the directional buttons.

10. The method of claim 7, wherein the universal remote control includes a plurality of buttons and the step of sequentially turning on the lights includes actuating at least one of the buttons.

11. The method of claim 7, wherein the universal remote control includes a plurality of buttons and the step of programming the processor includes actuating at least one of the buttons.

12. The method of claim 7, further including causing one of the lights to blink after the processor has been programmed.

13. The method of claim 1, wherein each of the devices has a code associated therewith, the universal remote control includes a plurality of buttons and the step of programming the processor includes sequentially turning on the lights by actuating at least one of the buttons to enter the code for a particular device.

14. A method for adapting a universal remote control unit to generate device command signals for controlling a selected one of a plurality of devices of different categories, the universal remote control unit having a plurality of lights corresponding to each device category and a processor having a programming mode for programming the processor to control a particular device; which method comprises:
setting the selected device to execute an observable action upon receipt of a response-evoking signal;
sequentially turning on each of the lights;
placing the processor in the programming mode when the light associated with the device category of the particular device it is desired to program is lit;
programming the processor to operate the particular device when the processor is in the programming mode by transmitting in sequence a plurality of response command signals each commanding the predetermined action until the selected device executes the observable action; and
terminating the programming of the processor when the device executes the observable action.

15. A universal remote control unit for remotely controlling a plurality of remotely controllable devices each belonging to a respective device category, the universal remote control unit comprising:
a plurality of lights corresponding to each device category;
a keyboard having a plurality of buttons for providing respective keyboard output signals upon user activation of respective ones of the buttons, the plurality of buttons including a first group of functional buttons and a second group of digit buttons;
means for sequentially turning on each of the light in response to actuation of at least one of the functional buttons;
a processor having a programming mode for programming the processor to control a particular device;
means responsive to actuation of at least one of the functional buttons when the light associated with the device category of the particular device it is desired to program is lit for placing the processor in the programming mode; and
means responsive to actuation of at least one of the functional or digit buttons when the processor is in the programming mode for programming the processor to operate the particular device.

16. A universal remote control unit for remotely controlling a plurality of remotely controllable devices each belonging to a respective device category, the universal remote control unit comprising:
a plurality of lights corresponding to each device category;
a keyboard having a plurality of buttons for providing respective keyboard output signals upon user activation of respective ones of the buttons, the plurality of buttons including a first group of functional buttons and a second group of digit buttons;
means for sequentially turning on each of the light in response to actuation of at least one of the functional buttons;
a processor having a programming mode for programming the processor to control a particular device;
means responsive to actuation of at least one of the functional buttons when the light associated with the device category of the particular device it is desired to program is lit for placing the processor in the programming mode; and
means responsive to actuation of at least one of the functional or digit buttons when the processor is in the programming mode for programming the processor to operate the particular device; and
a transmitter operative under control of the processor data to transmit device control signals towards the selected one of the plurality of devices in the specific one of the different categories of devices as determined by the actuation of at least one of the functional or digit buttons.

17. A universal remote control unit for remotely controlling a plurality of remotely controllable devices each belonging to a respective device category, the universal remote control unit comprising:
a plurality of lights corresponding to each device category;
a keyboard having a plurality of buttons for providing respective keyboard output signals upon user activation of respective ones of the buttons, the plurality of buttons including a first group of functional buttons and a second group of digit buttons;
means for sequentially turning on each of the light in response to actuation of at least one of the functional buttons;
a processor having a programming mode for programming the processor to control a particular device;
means responsive to actuation of at least one of the functional buttons when the light associated with the device category of the particular device it is desired to program is lit for placing the processor in the programming mode; and
means responsive to actuation of at least one of the functional when the processor is in the programming mode for programming the processor to operate the particular device; and
a transmitter operative under control of the processor data to transmit device control signals towards the selected one of the plurality of devices in the specific one of the different categories of devices as determined by the actuation of at least one of the functional or digit buttons.

18. A universal remote control unit for remotely controlling a plurality of remotely controllable devices each belonging to a respective device category, the universal remote control unit comprising:
a plurality of lights corresponding to each device category;
a keyboard having a plurality of buttons for providing respective keyboard output signals upon user activation of respective ones of the buttons, the plurality of buttons including a first group of functional buttons and a second group of digit buttons;
means for sequentially turning on each of the light in response to actuation of at least one of the functional buttons;
a processor having a programming mode for programming the processor to control a particular device;
means responsive to actuation of at least one of the functional buttons when the light associated with the device category of the particular device it is desired to program is lit for placing the processor in the programming mode; and
means responsive to actuation of at least one of the digit buttons when the processor is in the programming mode for programming the processor to operate the particular device; and
a transmitter operative under control of the processor data to transmit device control signals towards the selected one of the plurality of devices in the specific one of the different categories of devices as determined by the actuation of at least one of the functional or digit buttons.

19. A method of enabling a universal remote control to remotely control a plurality of remotely controllable devices each belonging to a respective device category, the universal remote control unit having a plurality of lights corresponding to each device category, a processor having a programming mode for programming the processor to control a particular device, and a keyboard having a plurality of buttons for providing respective keyboard output signals upon user activation of respective ones of the buttons, the plurality of buttons including a first group of functional buttons and a second group of digit buttons; which method comprises:
(a) user activation of at least one of the functional buttons to cause the lights to turn on in sequence;
(b) user activation of at least one of the functional buttons when the light associated with the device category of the particular device it is desired to program is lit for placing the processor in the programming mode; and
(c) user actuation of at least one of the functional or digit buttons when the processor is in the programming mode for programming the processor to operate the particular device.

20. The method of claim 19, wherein;
step (c) key comprises user activation of at least one of the digit buttons.

21. The method of claim 19, wherein:
step (c) comprises activation of at least two digit buttons, the combination of which represents a model number of a manufacturer of a device.

22. The method of claim 19, wherein step (a) comprises user activation of a first one of the functional buttons to cause a first one of the lights to turn on, followed by actuation of at least a second one of the functional buttons to cause the first light to turn off and a second light to turn on.

23. The method of claim 22, wherein the second button is a directional button.

24. The method of claim 19, wherein in step (a) the lights are cause to stay on for a predetermined period of time.

25. The method of claim 19, further including actuating at least one functional button after step (c) to enable programming of another particular device.
